(19) United States
(12) Patent Application Publication
(10) Pub. No.: US 2017/0254686 A1
(43) Pub. Date: Sep. 7, 2017

(54) FLOW SENSOR ASSEMBLY

(71) Applicant: Sam Royhob, Orange, CA (US)

(72) Inventor: Sam Royhob, Orange, CA (US)

(21) Appl. No.: 15/059,391

(22) Filed: Mar. 3, 2016

(51) Int. Cl. G01F 1/69

(52) U.S. Cl. CPC G01F 1/69

(57) ABSTRACT

A sensor assembly for measuring a flow rate of a fluid is disclosed herein having an enclosure, a substrate positioned in the enclosure, the substrate having a first side and a second side opposite the first side, a first temperature sensor mounted on the first side of the substrate, a second temperature sensor mounted on the second side of the substrate, a heat source mounted on the first side of the substrate and a circuit connected to the first and second temperature sensors and outputting a signal indicative of a flow rate for the fluid. In one arrangement, the circuit can include a bridge circuit having first, second and third circuit branches wherein the third circuit branch bridges the first circuit branch with the second circuit branch and wherein the first temperature sensor is connected within the first circuit branch and the second temperature sensor is connected within the second circuit branch.

### FIELD

The present invention pertains generally to sensors for sensing and/or measuring fluid flow. More particularly, the present invention pertains to flow sensors which generate heat in a fluid and monitor a parameter to determine fluid flow.

### BACKGROUND

It is often desirable to determine whether fluid is flowing, for example through a conduit such as a pipe, or to determine a quantitative measurement of fluid flow. As an example, in jetted baths, pools, and hot tubs, flow sensing devices are often used as a safety measure, to disengage a water heater before the heater overheats when water flow through the heater falls below a level sufficient to maintain the heater cool enough to operate safely.

The water found in pools and, more particularly, hot tubs, is often present at elevated temperatures and can include relatively harsh chemicals (e.g. chlorine). This heated/chemically treated water can present a relatively harsh environment to components such as sensors and switches. For this reason, suitable methods of flow detection have generally included mechanical flow switches, pressure switches, and vacuum switches. Unfortunately, mechanical flow switches tend to be bulky and are often prone to mechanical failure. In addition, pressure and vacuum switches can be unreliable due to the fact that they don't truly measure the flow of water, but instead, measure the amount of pressure or vacuum in the plumbing at the location of the switch. Another problem with these types of switches is that they force installers to plumb the heater to either the suction or discharge side of the water pump depending on which type of switch is used in the equipment being installed. For this reason, installation/plumbing options are often limited and this limitation can often lead to an increase in the time required to perform the installation and/or the difficulty of the install.

U.S. Pat. No. 6,282,370 to Cline et al discloses a solid state water temperature sensor apparatus that provides electrical temperature signals to the controller indicative of water temperature at separated first and second locations on or within the heater housing. For the system of Cline et al, the presence of water in the heater housing is detected electronically, by turning on the heater, and monitoring the temperature sensors for unusual temperature rises or other faults for a period of time thereafter. However, one drawback associated with the Cline et al system is that it requires installation of sensor components at two, spaced apart locations. This limitation can be costly, time consuming and can require the fabrication of two sensor component input ports. Also, each extra port can be a potential leak site.

U.S. Pat. No. 5,243,858 to Erskine et al discloses an airflow sensor formed on a silicon chip that comprises a silicon base covered with an insulating polyimide layer, a lineal resistance heater on the chip energized with current pulses to propagate thermal waves, and a temperature sensor on the chip downstream of the heater to detect the arrival of each thermal wave. For the Erskine sensor, circuitry determines flow rate as a function of the measured propagation time of the thermal wave. However, one shortcoming associated with the Erskine sensor is that the direction from the lineal resistance heater and temperature sensor must be aligned with the flow direction to use the Erskine sensor.

In light of the above, Applicant's disclose a flow sensor assembly and corresponding methods of using a flow sensor assembly.

### SUMMARY

In a first aspect, a sensor assembly for measuring a flow rate of a fluid is disclosed having an enclosure, a substrate positioned in the enclosure and having a first side and a second side opposite the first side, a first temperature sensor mounted on the first side of the substrate, a second temperature sensor mounted on the second side of the substrate, a heat source mounted on the first side of the substrate and a circuit connected to the first and second temperature sensor and outputting a signal indicative of a flow rate for the fluid.

In one embodiment the enclosure is made of a thermally conductive material and in a particular embodiment the enclosure is made of metal.

In one particular embodiment, the first and second temperature sensors have the same resistance dependence on temperature. The heat source can consist of a single resistance element or a plurality of resistance elements.

In one embodiment, the substrate can be a single printed circuit board, e.g. a monolithic printed circuit board. For this embodiment, the first temperature sensor, second temperature sensor and/or heat source can be mounted on the printed circuit board using surface mounting. In another embodiment, the substrate can include first and second printed circuit boards that are separated by a spacer. For example, the spacer can be made of a thermally insulating material. For this embodiment, the first temperature sensor, second temperature sensor and/or heat source can be mounted on the printed circuit boards using through-hole mounting.

In one implementation, thermal grease is disposed between the temperature sensors and the enclosure and in a particular embodiment, the entire space within the enclosure that is not occupied by the substrate, temperature sensors and heat source is filled with thermal grease.

For this aspect, the circuit can include a bridge circuit having first, second and third circuit branches wherein the third circuit branch bridges the first circuit branch with the second circuit branch and wherein the first temperature sensor is connected within the first circuit branch and the second temperature sensor is connected within the second circuit branch. In one implementation the bridge circuit includes a potentiometer to balance the bridge circuit during a non-flow condition, in another implementation, the potentiometer is replaced with fixed value resistors known to balance the bridge during a non-flow condition.

In one embodiment, the circuit includes a voltage comparator receiving an output from the bridge circuit and includes a relay receiving an input from the voltage comparator and outputting a voltage for switching a device between at least two switch states. For example, the device may be a heater that is switched on once a safe flow rate has been established and switched off when flow drops below a safe flow rate. In another embodiment, the circuit can include a voltage comparator receiving an input from the bridge circuit, an analog to digital (A/D) chip receiving an output from the voltage comparator, a computer processing unit (CPU) receiving a digital signal from the A/D chip and one or more user perceptible output device(s) receiving an output from the CPU. For example, the user perceptible output device can be a display screen for presenting a numerical value, a warning light or a speaker. In some setups, the output from the circuit can be used to produce a user perceptible output and switch a device between switch states.

In another aspect, a sensor assembly for measuring a flow rate of a fluid is disclosed having an enclosure, a heat source positioned in the enclosure, a first temperature sensor positioned in the enclosure and distanced from the heat source by a distance, D₁, a second temperature sensor positioned in the enclosure and distanced from the heat source by a distance, D₂, with D₂>D₁, and a circuit connected to the first and second temperature sensor and outputting a signal indicative of a flow rate for the fluid.

In one embodiment of this aspect, the sensor assembly can include a substrate positioned in the enclosure with the first temperature sensor, second temperature sensor and heat source mounted on the substrate.

In another aspect, a method for measuring a flow rate of a fluid is disclosed including the steps of providing an enclosure, positioning a substrate in the enclosure having a first temperature sensor and a heat source mounted on a first side of the substrate and a second temperature sensor mounted on a second side of the temperature sensor, the second side opposite the first side, connecting a circuit to the first and second temperature sensor, immersing at least a portion of the enclosure in the fluid and outputting a signal indicative of a flow rate for the fluid. In one implementation, the method can include the step of using the signal to switch a device between at least two switch states and in another implementation, the method can include the step of using the signal to produce a user perceptible output.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view illustrating a sensor assembly for measuring a flow rate of a fluid, the sensor assembly having a probe component and a controller component;

FIG. 2 is a schematic sectional view illustrating a probe component of a sensor assembly for measuring a flow rate of a fluid shown with the probe component operationally positioned in a tubular conduit;

FIG. 3 is a schematic sectional view illustrating another embodiment of a probe component having a substrate that includes first and second printed circuit boards that are separated by a spacer, shown with the probe component operationally positioned in a tubular conduit;

FIG. 4 is an electrical schematic showing electrical components for an embodiment which outputs a signal indicative of fluid flow to a display;

FIG. 5 is a flow chart showing a sequence of steps suitable for calibrating and using a sensor assembly for measuring a flow rate of a fluid;

FIG. 6 is a schematic view illustrating a sensor assembly for measuring a flow rate of a fluid and outputting a signal indicative of fluid flow suitable for switching a device between at least two switch states;

FIG. 7 is a cross-sectional view as seen along line 7-7 in FIG. 6 showing a circuit of electrical components (shown schematically) for outputting a signal indicative of fluid flow suitable for switching a device between at least two switch states; and

FIG. 8 is a schematic of a hot tub having a heater, pump and filter showing locations suitable for monitoring fluid flow using a sensor assembly as described herein.

### DESCRIPTION

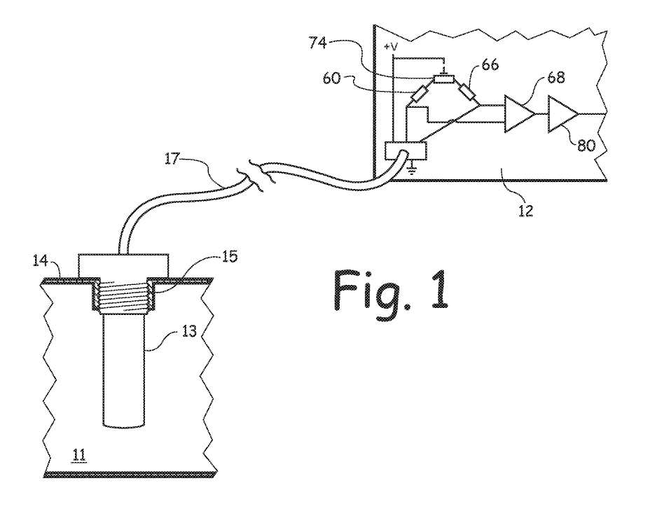

With initial reference to FIG. 1, a sensor assembly 10 (generally designated 10) for measuring a flow rate of a fluid 11 is shown having a controller portion 12 and a sensor probe portion (probe 13) that is operationally positioned in a tubular conduit 14 via threaded port 15. As shown, controller portion 12 is connected to probe 13 via multi-wire cable 17.

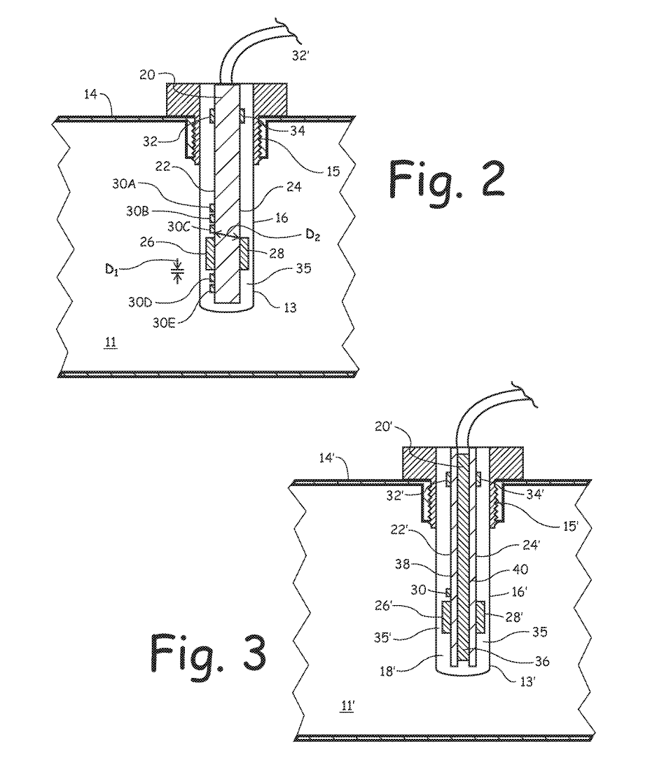

Referring now to FIG. 2, it can be seen that the probe 13 includes an enclosure 16 which surrounds a volume 18 and is at least partially submersed in the fluid 11. For the sensor assembly 10, the enclosure can be made of a thermally conductive material, for example, a metal such as Stainless Steel or Titanium Alloy can be used.

Continuing with FIG. 2, it is further shown that the probe 13 can include a substrate 20, at least a portion of which is positioned in the enclosure 16. As shown, the substrate 20 is formed with a first side 22, having a relatively flat surface and a second side 24 opposite side 22 and having a relatively flat surface. For example, the substrate 20 can be a single printed circuit board. In some cases, the substrate 20 can be a single printed circuit board that is relatively thick (i.e. thick enough to thermally isolate temperature sensor 28 from the heat source resistors 30A-C sufficiently to allow the sensor assembly 10 to output meaningful flow rate data). For example, for a sensor assembly 10 sized for a 2″ tubular conduit, a thickness in the range of 2 to 3 mm between side 22 and side 24 may suffice for some applications.

FIG. 2 further shows that a temperature sensor 26 is mounted on the side 22 of the substrate 20 and a temperature sensor 28 is mounted on the side 24 of the substrate 20. For example, the temperature sensors 26, 28 can be PTC thermistors or integrated-circuit (IC) temperature sensors, and typically, both temperature sensors 26, 28 are of the same type and rating (e.g., having the same resistance dependence on temperature). For example, the temperature sensors 26, 28 can be Texas Instruments Model #LM50BIM3/NOPB.

Continuing with FIG. 2, it can be seen that the probe 13 includes a heat source consisting of a plurality of resistance elements (resistors 30A-E), with each resistor 30A-E mounted on the first side 22 of the substrate 20 in relatively close proximity to the temperature sensor 26. Although a heat source having five resistors 30A-E is shown, it is to be appreciated that more than five and as few as one resistance elements (see FIG. 2 and discussion below) may be used for the sensor assemblies described herein. For the probe 13, the temperature sensors 26, 28, heat source resistors 30A-E and resistors 32, 34 (described further below) can be mounted on the printed circuit board substrate 20 using surface mounting. Alternatively, resistors 32, 34 could be provided in the controller 12 portion (see FIG. 1). FIG. 2 also shows that temperature sensor 26 is distanced from the nearest heat source resistor (in this case resistor 30D by a distance, D₁, temperature sensor 28 is distanced from the nearest heat source resistor (in this case resistor 30C by a distance, D₂, with D₂>D₁. Also for the probe 13, the volume 18 can be filled with a thermally conductive material such as thermal grease 35. The thermally conductive material provides a thermal conduction path between the heat source resistors 30A-E and the temperature sensor 26 and between the temperature sensors 26, 28 and the enclosure 16.

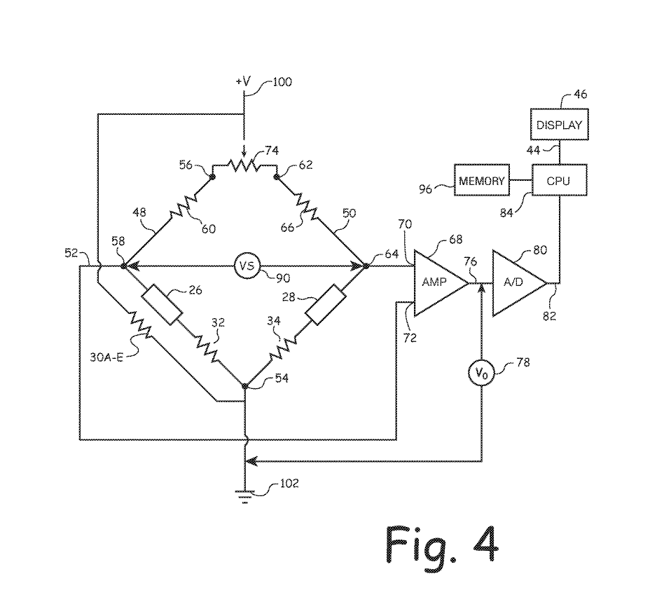

Referring now to FIG. 3, another embodiment of a sensor probe 13′ for measuring a flow rate of a fluid 11′ is shown operationally positioned in a tubular conduit 14′ via threaded port 15′. As shown, the probe 13′ includes an enclosure 16′ (as described above) which surrounds a volume 18′ and is at least partially submersed in the fluid 11′.

Continuing with FIG. 3, it is further shown that the probe 13′ can include a substrate 20′, at least a portion of which is positioned in the enclosure 16′. As shown, the substrate 20′ includes a spacer 36 sandwiched between two printed circuit boards 38, 40. For example, the spacer 36 can be made of a thermally insulating material such as plastic, a foam material or Silicone and have a thickness sufficient to thermally isolate temperature sensor 28′ from the heat source resistor 30 sufficiently to allow the sensor assembly 10′ to output meaningful flow rate data). For example, for a sensor assembly 10′ sized for a 2″ tubular conduit 14′, a thickness in the range of 1 to 3 mm may suffice for some applications. With this arrangement, the substrate 20′ has a first side 22′ on printed circuit board 38, having a relatively flat surface and a second side 24′ on printed circuit board 40, opposite side 22′, and also having a relatively flat surface.

FIG. 3 further shows that a temperature sensor 26′ (as described above) is mounted on the side 22′ of the substrate 20′ and a temperature sensor 28′ (as described above) is mounted on the side 24′ of the substrate 20′. The probe 13′ also includes a heat source consisting of a single resistance element (resistor 30), mounted on the first side 22′ of the substrate 20′ in relatively close proximity to the temperature sensor 26′. For the probe 13′, the temperature sensors 26′, 28′, heat source resistor 30 and resistors 32′, 34′ (described further below) can be mounted on the printed circuit boards 38, 40 using through-hole mounting. Also for the probe 13′, the volume 18′ can be filled with a thermally conductive material such as thermal grease 35′. An example of a suitable thermal grease is Laird Technologies Tgrease 880. Generally, thermal grease consists of a polymerizable liquid matrix including epoxies, silicones, urethanes, and acrylates and a large volume fraction of electrically insulating, but thermally conductive filler such as aluminum oxide, boron nitride and/or zinc oxide.

FIG. 4 shows a circuit (generally designated 42) connecting the electrical components of probe 13 shown in FIG. 2 (and by analogy the components of probe 13′ in FIG. 3) and outputting a signal 44 indicative of a fluid flow rate to display 46. As shown, the circuit 42 can include a bridge circuit having first circuit branch 48, second circuit branch 50 and third circuit branch 52 wherein the third circuit branch 52 bridges the first circuit branch 48 with the second circuit branch 50. In further detail, as shown, the first circuit branch 48 extends from node 54 to node 56 and includes, in order, node 54, resistor 32, temperature sensor 26, node 58, resistor 60 and node 56. Second circuit branch 50 extends from node 54 to node 62 and includes, in order, node 54, resistor 34, temperature sensor 28, node 64, resistor 66 and node 62. Third circuit branch 52 includes a voltage comparator, which can be for example, amp 68 having input 70 connected to node 64 and input 72 connected to node 58. Also shown, a potentiometer 74, which can act, for example, as a variable voltage divider, is connected to node 56 and to node 62. Amp 68 outputs an analog signal 76 having varying voltage V₀, relative to ground (illustrated by voltage meter 78). Analog signal 76 is received by analog to digital (A/D) chip 80 which then sends a digital signal 82 to computer processing unit (CPU) 84 which processes the digital signal 82 (as described further below) and outputs an appropriate signal 44 to a device for producing user perceptible output such as display 46.

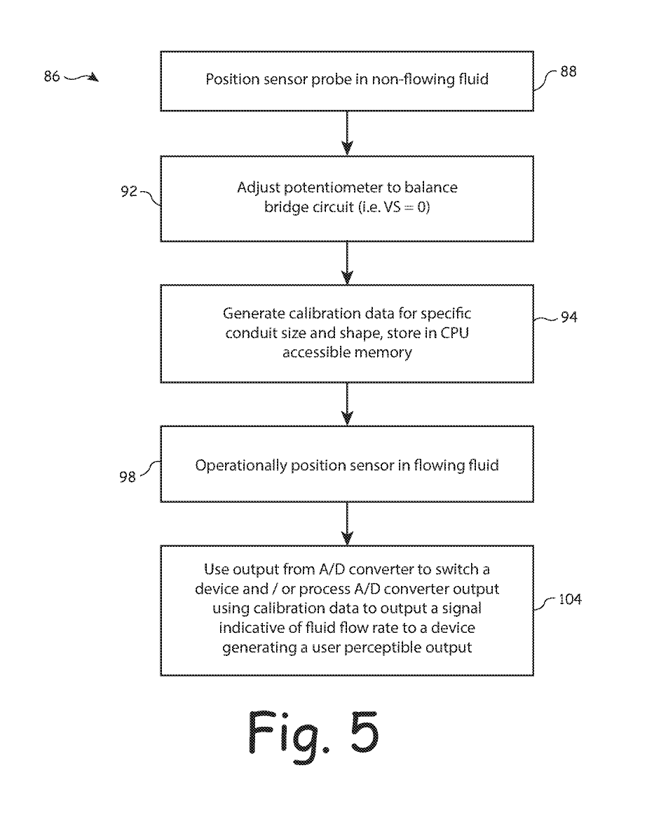

FIG. 5 shows a sequence of steps (generally designated 86) suitable for calibrating and using a sensor assembly 10 (FIG. 1) for measuring a flow rate of a fluid. As seen there, the sensor assembly 10 is first initialized by placing the probe 13 in a non-flowing fluid (box 88). With the probe 13 immersed in a non-flowing fluid, current is passed through the heat source resistors 30A-E and the potentiometer 74 is adjusted (box 92) to balance the bridge circuit (i.e. until the voltage VS measured by voltage meter 90 (FIG. 4) between node 58 and node 64 is approximately zero. This initialization can be performed offsite (i.e. at the ‘factory’) or at the site of installation. It will be appreciated that the voltage meters 78, 90 do not necessarily form a part of the sensor assemblies as claimed herein. Alternatively, bridge resistances necessary to achieve a balanced bridge circuit during immersion in a non-flowing fluid may be calculated and/or measured and a bridge circuit having fixed resistors (i.e. a bridge circuit without a potentiometer) may be employed.

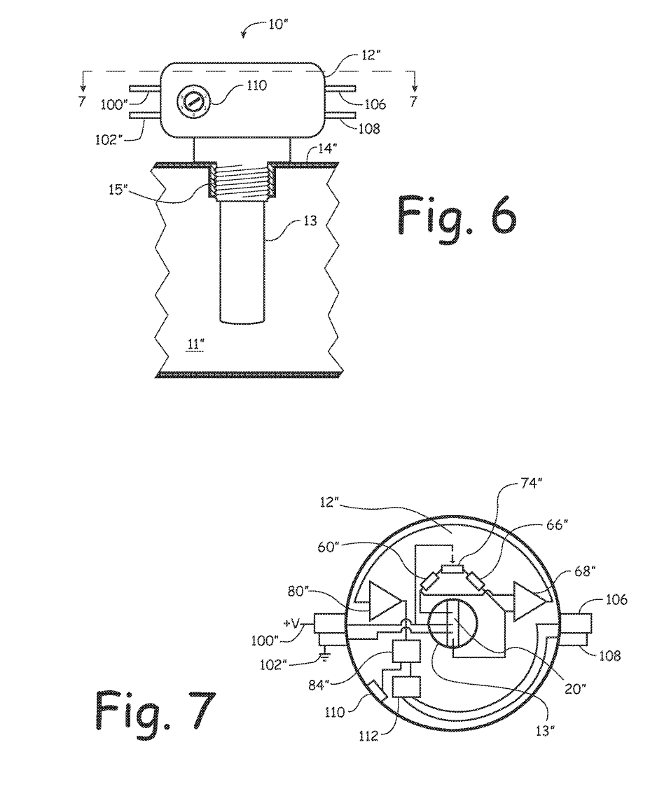

Continuing with FIG. 5, once the sensor assembly has been initialized, calibration data can be generated (box 94) for a specific conduit size and shape and stored in CPU accessible memory 96 (see FIG. 4). For example, calibration data can be measured for a one inch, two inch and three inch pipe. As an example, one or more known flow rates can be established in the pipe, and for each known flow rate, an output signal (e.g. signal 82 in FIG. 4) can be measured to produce the calibration data. Once calibrated, the probe can be operationally positioned to measure flow (box 98), for example, in the plumbing of a spa, pool or the like. As box 104 indicates, once the probe is operationally installed and connected to a voltage source 100 and ground 102 (see FIG. 4), the output from the A/D chip 80 can be used to switch a device (see description below regarding FIGS. 6 and 7) and/or processed using calibration data to output a signal indicative of fluid flow rate to a device generating a user perceptible output. In most cases, the probe does not necessarily need to be oriented relative to the flow direction to produce meaningful flow rate data (i.e. the side 22 of the substrate 20 shown in FIG. 2 does not necessarily need to be oriented orthogonal to the flow direction). Moreover, the arrangements described herein have been found to be relatively insensitive to fluid temperature, and can be used to produce meaningful flow rate data over a relatively large range of fluid temperature, in particular, over the range of water temperatures normally present in jetted baths, pools, and hot tubs.

FIG. 6 shows a sensor assembly (generally designated 10″) for measuring a flow rate of a fluid 11″ having a controller portion 12″ and a sensor probe portion (probe 13″ having substrate 20″ (see FIG. 7)) that is operationally positioned in a tubular conduit 14″ via threaded port 15″. For the sensor assembly 10″, the probe 13 (FIG. 2), the probe 13′ (FIG. 2) or some other suitable probe configuration can be used. For the sensor assembly 10″, the controller portion 12″ is configured to output a voltage, based on a measured flow rate, to a switch circuit via terminals 106, 108. For example, a heater and/or pump may be connected to the terminals 106, 108 and switched between ON and OFF states by the sensor assembly 10″ based on the signal produced by the sensor assembly 10″ that is proportional to flow rate.

As best seen in FIG. 7, the controller portion 12″ includes voltage source terminal 100″, ground terminal 102″, resistors 60″, 66″, potentiometer 74″, amp 68″, A/D chip 80″, CPU chip 84″, all as described above with reference to FIG. 4. Also, as shown, it can be seen that the CPU chip 84 can receive an input from an adjustment switch 110, for example, allowing the controller portion 12″ to change between switch states based on a selected, user-input flow rate. The output from the CPU chip 84″ is received by relay 112 which generates the output to terminals 106, 108.

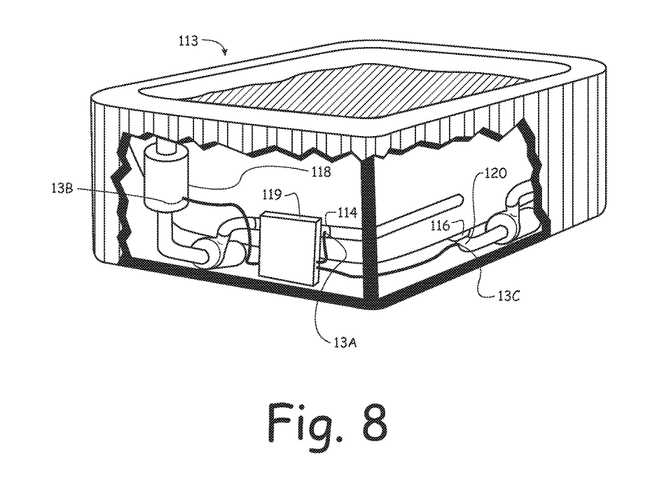

FIG. 8 shows a hot tub 113 having a heater 114, suction fitting 116 and filter 118 showing optional locations suitable for monitoring fluid flow monitoring by the hot tub's control system 119. For example, probe 13A can be placed in the heater tube 114 to monitor the flow going through it, as a safety measure so that the control system 119 can terminate heating if flow drops below safe levels. Also shown, probe 13B can be placed within the filter housing 118, to monitor the flow through the filter's cartridge, so the control system 119 can let the user know when the filter cartridge needs to be replaced. FIG. 8 also shows that probe 13C can be placed in conduit 120 just downstream of the tub's suction fitting 116 to monitor flow through it, as a safety measure so that the control system can terminate operation of the pump(s) and/or alert the user if there appears to be blockage at the suction fitting 116.

While the particular flow sensor assemblies and corresponding methods of initialization, calibration and use as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A sensor assembly for measuring a flow rate of a fluid comprising:
an enclosure;
a substrate positioned in the enclosure and having a first side and a second side opposite the first side;
a first temperature sensor mounted on the first side of the substrate;
a second temperature sensor mounted on the second side of the substrate;
a heat source mounted on the first side of the substrate; and
a circuit connected to the first and second temperature sensors and outputting a signal indicative of a flow rate for the fluid.

2. A sensor as recited in claim 1 wherein the enclosure is made of a thermally conductive material.

3. A sensor as recited in claim 1 wherein the enclosure is made of metal.

4. A sensor as recited in claim 1 wherein the first and second temperature sensors have the same resistance dependence on temperature.

5. A sensor as recited in claim 1 wherein the heat source comprises a plurality of resistance elements.

6. A sensor as recited in claim 1 wherein the substrate comprises a single printed circuit board.

7. A sensor as recited in claim 6 wherein the first temperature sensor is mounted on the single printed circuit board using surface mounting.

8. A sensor as recited in claim 1 wherein the substrate comprises first and second printed circuit boards separated by a spacer.

9. A sensor as recited in claim 8 wherein the first temperature sensor is mounted on the first printed circuit board using through-hole mounting.

10. A sensor as recited in claim 1 further comprising thermal grease disposed between the substrate and the enclosure.

11. A sensor as recited in claim 1 wherein the circuit comprises a bridge circuit having first, second and third circuit branches wherein the third circuit branch bridges the first circuit branch with the second circuit branch and wherein the first temperature sensor is connected within the first circuit branch and the second temperature sensor is connected within the second circuit branch.

12. A sensor as recited in claim 11 wherein the circuit further comprises a potentiometer to balance the bridge circuit during a non-flow condition.

13. A sensor as recited in claim 11 wherein the circuit further comprises a voltage comparator receiving an output from the bridge circuit and a relay receiving an input from the voltage comparator and outputting a voltage for switching a device between at least two switch states.

14. A sensor as recited in claim 11 wherein the circuit further comprises a voltage comparator receiving an input from the bridge circuit, an analog to digital (A/D) chip receiving an output from the voltage comparator, a computer processing unit (CPU) receiving a digital signal from the A/D chip and a user perceptible output device receiving an output from the CPU.

15. A sensor as recited in claim 14 wherein the user perceptible output device is selected from the group of user perceptible output devices consisting of a display screen for presenting a numerical value, a warning light and a speaker.

16. A sensor assembly for measuring a flow rate of a fluid comprising:
an enclosure;
a heat source positioned in the enclosure;
a first temperature sensor positioned in the enclosure and distanced from the heat source by a distance, D₁;
a second temperature sensor positioned in the enclosure and distanced from the heat source by a distance, D₂, with D₂>D₁; and
a circuit connected to the first and second temperature sensors and outputting a signal indicative of a flow rate for the fluid.

17. A sensor as recited in claim 16 further comprising a substrate positioned in the enclosure with the first temperature sensor, second temperature sensor and heat source mounted on the substrate.

18. A method for measuring a flow rate of a fluid comprising the steps of:
providing an enclosure;
positioning a substrate in the enclosure having a first temperature sensor and a heat source mounted on a first side of the substrate and a second temperature sensor mounted on a second side of the temperature sensor, the second side opposite the first side;
connecting a circuit to the first and second temperature sensors;
immersing at least a portion of the enclosure in the fluid; and
outputting a signal indicative of a flow rate for the fluid.

19. A method as recited in claim 18 further comprising the step of using the signal to switch a device between at least two switch states.

20. A method as recited in claim 18 further comprising the step of using the signal to produce a user perceptible output.
